(19) United States
(12) Patent Application Publication
(10) Pub. No.: US 2026/0248327 A1
(43) Pub. Date: Aug. 27, 2026

(54) Baby Washing Apparatus

(71) Applicant: Peigen Jiang, sammamish, WA (US)

(72) Inventor: Peigen Jiang, sammamish, WA (US)

(21) Appl. No.: 19/063,268

(22) Filed: Feb. 25, 2025

(51) Int. Cl. A47K 3/12

(52) U.S. Cl. CPC A47K 3/127

(57) ABSTRACT

An apparatus for washing baby includes a basket for carrying the baby, the basket having a bottom opening for exposing a bottom area of the baby, and a crane suspending the basket for placing the bottom opening over a water stream.

### BACKGROUND

The present disclosure relates generally to the field of baby hygiene, and, more particularly, to a baby washing apparatus.

A few months old baby typically soils his or her diapers four to six times a day. Changing a soiled diaper generally requires removing the soiled diaper and wiping the baby clean with moist fabrics. Wiping itself is time consuming, messy and malodorous, leaves residue and tends to inflame and aggravate diaper rash. The fabrics are often made from a blend of polyester and viscose or cotton and then moistened with a chemical containing solution. Using a large amount of these moist fabrics is expensive and harmful to the environment.

As such, what is desired is a washing apparatus that facilitates the use of water to clean babies.

### BRIEF DESCRIPTION OF THE DRAWING

FIG. 1 is a perspective view of a baby washing apparatus according to embodiments of the present disclosure.

FIG. 2A is a perspective view of a back side of a back panel according to embodiments of the present disclosure.

FIG. 2B is a perspective view of a back side of an alternative back panel according to embodiments of the present disclosure.

FIG. 3 is a perspective view of the bottom panel and associated frame members according to embodiments of the present disclosure.

FIGS. 4A and 4B are perspective views of the stand of the crane shown in FIG. 1.

FIG. 5 is a perspective view of a part of the crane according to embodiments of the present disclosure

The drawings accompanying and forming part of this specification are included to depict certain aspects of the disclosure. A clearer conception of the disclosure, and of the components and operation of systems provided with the disclosure, will become more readily apparent by referring to the exemplary, and therefore non-limiting, embodiments illustrated in the drawings, wherein like reference numbers (if they occur in more than one view) designate the same elements. The disclosure may be better understood by reference to one or more of these drawings in combination with the description presented herein.

### DESCRIPTION

The present disclosure relates to a baby washing apparatus that facilitates the use of a water from a bidet for cleaning a baby. A preferred embodiment of the present disclosure will be described hereinafter with reference to the attached drawings.

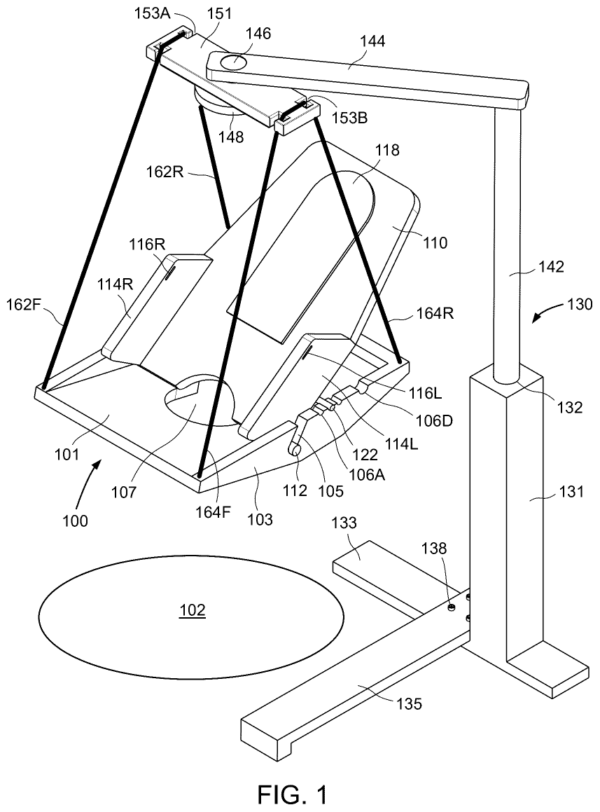

FIG. 1 is a perspective view of a baby washing apparatus according to embodiments of the present disclosure. The exemplary baby washing apparatus includes a basket 100 suspended by a crane 130 using ropes 162F, 162R, 164F and 164R. The basket 100 is used for carrying a baby over a bidet 102 that can provide a water stream for cleaning the baby's bottom through an opening 107 of the basket 100. The crane 130 has a swivel jib 144 to move the basket 100 between a first position that is above the bidet 102 and a second position that is away from the bidet 102. When the basket 100 is at the first position, the baby's bottom is exposed, through the opening 107, to the water stream from the bidet 102. The ropes 162F, 162R, 164F and 164R allow the basket 100 to swing around at a nudge of a caregiver, so that a large area of the baby's bottom can be washed. When the basket 100 is at the second position, the basket 100 is away from the bidet 102, so that the bidet 102 can be used regularly by, for instance, an adult.

Referring again to FIG. 1, the basket 100 includes a bottom panel 101 for the baby to sit on and a back panel 110 for the baby's upper body to rest on. In an embodiment, a rear area of the bottom panel 101 overlaps a lower edge of the back panel 110, so that the bottom panel 101 and the back panel 110 form a chair.

Referring again to FIG. 1, the back panel 110 can pivot around an axle 112 that is situated in a notch 105 formed in a side frame 103. The side frame 103 is perpendicularly fixed to the bottom panel 101. The back panel 110 can pivot between a first and second angle of inclination in reference to the bottom panel 101. At the first angle, the back panel 110 is relatively more upright; and at the second angle, the back panel 110 lays relatively flatter. The back panel 110 is kept in the first or second angle by engaging a rod 122 with a different groove 106A or 106D formed on the top side of the side frame 103. The rod 122 can slide up and down along a back side (not shown) of the back panel 110. The groove 106A is disposed closer to the notch 105 than the groove 106D. When the slidable rod 122 engages the groove 106A, the back panel 110 is secured by the slidable rod 122 at a relatively upright position with the first angle. When the slidable rod 122 engages the groove 106D, the back panel 110 rests on the slidable rod 122 at a relatively horizontal position with the second angle. With the notch 105 being fixed on the side frame 103, locations the exemplary grooves 106A and 106D on the side frame 103 determine the first and second angles of the back panel 110. In an embodiment, when the back panel 110 is at the relatively upright position, the first angle between the back panel 110 and the bottom panel 101 is 60-80 degrees; when the back panel 110 is at the relatively horizontal position, the second angle between the back panel 110 and the bottom panel 101 is between 10-30 degrees.

Referring again to FIG. 1, the ropes 162F and 162R hang from a first end of an elongated board 151, and the ropes 164F and 164R hang from a second end of the elongated board 151. As shown in FIG. 1, the rope 162R falls in a notch 153A formed at the first end of the elongated board 151; and the ropes 164R falls in a notch 153B formed at the second end of the elongated board 151.

In an embodiment, the elongated board 151 can rotate around a shaft 146 fixed to an end of the jib 144, so that the basket 100 can be oriented at any angle relative to the stationary crane 130. Rotating the basket 100 is to accommodate a tight space between the bidet 102 and a water tank (not shown) behind the bidet 102. When the back panel 110 is at the relatively horizontal position, the basket 100 has to be oriented in parallel to a front surface of the water tank to fit in the tight space. When the back panel 110 is at the relatively upright position, the basket 110 can be oriented perpendicular to the front surface of the water tank with the back panel 110 leaning against the front surface of the water tank.

Referring again to FIG. 1, there are side guides 114L and 114R protruding from each side of the back panel 110 to prevent the baby from falling off the basket 100. In an embodiment, there is a slot 116L in the left side guide 114L and a slot 116R in the right side guide 114R for fastening a belt (not shown) to further secure the baby to the basket 100. The belt forms end loops to be secured to the slots 116L and 116R, respectively, and has a buckle in between the ends. When the buckle is released, the belt is separated into two pieces fastened to the right side guide 114R and left side guide 114L, respectively, to allow the baby to be placed in the basket 100. When the buckle is engaged, the belt forms one piece of strip spanning between the right side guide 114R and left side guide 114L to prevent the baby from falling out of the basket 100.

Referring again to FIG. 1, the bottom opening 107 is exemplarily formed by a cut-out in the bottom panel 101 joint by a cut-out in the back panel 110. In an embodiment, both the cut-outs are centered in respective panels 101 and 110 with a widest opening measured between 120 mm to 160 mm.

Referring again to FIG. 1, the crane 130 includes an x-axis base board 133, a y-axis base board 135, a vertical column 131 with a vertical round hole 132, a vertical pole 142 and the jib 144. The y-axis base board 135 is attached to the x-axis base board 133 by screw fasteners 138 forming a T-shaped structure that is laid on a floor. The vertical column 131 is fixedly attached to the x-axis base board 133 to stand vertically. In an embodiment, the vertical pole 142 is rotatably inserted in the vertical round hole 132 while the jib 144 is fixedly attached to a top end of the vertical pole 142, so that the jib 144 can swivel around an axis centered in the vertical round hole 132. In another embodiment, the vertical pole 142 is fixedly inserted in the vertical round hole 132, while the jib 144 can swivel around the top end of the vertical pole 142.

As shown in FIG. 1, there is an end plate 148 removably fastened to the shaft 146 to keep the elongated board 151 rotatably secured to the shaft 146 of the jib 144. When the end plate 148 is removed from the shaft 146, the elongated board 151 along with the basket 100 can be disengaged from the jib 144.

In operations, the caregiver initially lays down the back panel 110 to the relatively horizontal position and rotates the elongated board 151 to orient the basket 110 to be parallel to the water tank's front surface. Then the caregiver can place the baby in the basket 100 and remove the baby's clothes and diaper in preparation for washing. The caregiver can then buckle the belt to secure the baby to the basket 100. After the baby is secured, the caregiver can pivot the back panel 110 to the relatively upright position and rotate to elongated board 151 to orient the basket 110 to be perpendicular to the water tank's front surface. In an example, the back panel 110 leans against the water tank's front surface. At this position, the bottom opening 107 is situated on the path of the water stream of the bidet 102. The caregiver can then turn on the water stream to wash the baby's bottom. As the basket 100 is suspended by the ropes 162F, 162R, 164F and 164R slightly above the bidet 102, the caregiver can swing the basket 100 around to expose different areas of the baby's bottom to the water stream.

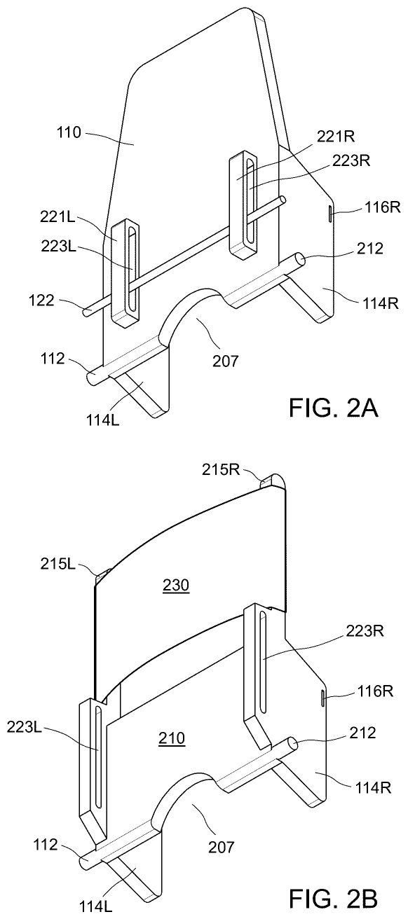

FIG. 2A is a perspective view of a back side of the back panel 110 according to embodiments of the present disclosure. Two elongated blocks 221L and 221R are fixedly attached to the back side of the back panel 110. The elongated block 221L has a slot 223L; and the elongated block 221R has a slot 223R. These slots 223L and 223R limit the rod 122 to slide in parallel to the back side of the back panel 110 for holding the back panel 110 at a particular angle as described above in association with FIG. 1.

Referring again to FIG. 2, an axle 212 is symmetrical to the axle 112. Both the axles 112 and 212 engage notches in the side frame of the bottom panel 101 to allow the back panel 110 to pivot between the relatively upright position and the relatively horizontal position as described above in association with FIG. 1.

Referring again to FIG. 2, the back panel 110 has a half-circular cut-out 207 at a lower edge of the back panel 110 to form a part of the opening 107 shown in FIG. 1.

FIG. 2B is a perspective view of a back side of an alternative back panel 110 according to embodiments of the present disclosure. The alternative back panel 110 has two sections: a lower back panel section 210 and an upper back panel section 230. As shown in FIG. 2B, the side guides 114R and 114L are fixedly attached to and border the sides of the lower back panel section 210. The side guides 114R and 114L perpendicularly extend to beyond a back surface of the lower back panel section 210. The slot 223R is formed on the extended portion of the side guide 114R; and the slot 223L is formed on the extended portion of the side guide 114L. The slots 223R and 223L are used to accommodate the slidable rod 122 (not shown).

As shown in FIG. 2B, the side guide 114R has an extended pole member 215R parallel to the back surface of the lower back panel section 210; the side guide 114L has an extended pole member 215L parallel to the back surface of the lower back panel section 210. The extended pole member 215R and 215L are used to secure the upper back panel section 230. In an embodiment, the lower back panel section 210 is made of a rigid material such as wood; and the upper back panel section 230 is made of a soft material such as a fabric. In an embodiment, the fabric forms a tube (not shown) at each side to accommodate the extended pole members 215R and 215L, respectively, so that the upper back panel section 230 is stretched between the extended pole members 215R and 215L. The fabric upper back panel section 230 can be easily removed from the extended pole members 215R and 215L by sliding the tubes off the extended pole members 215R and 215L.

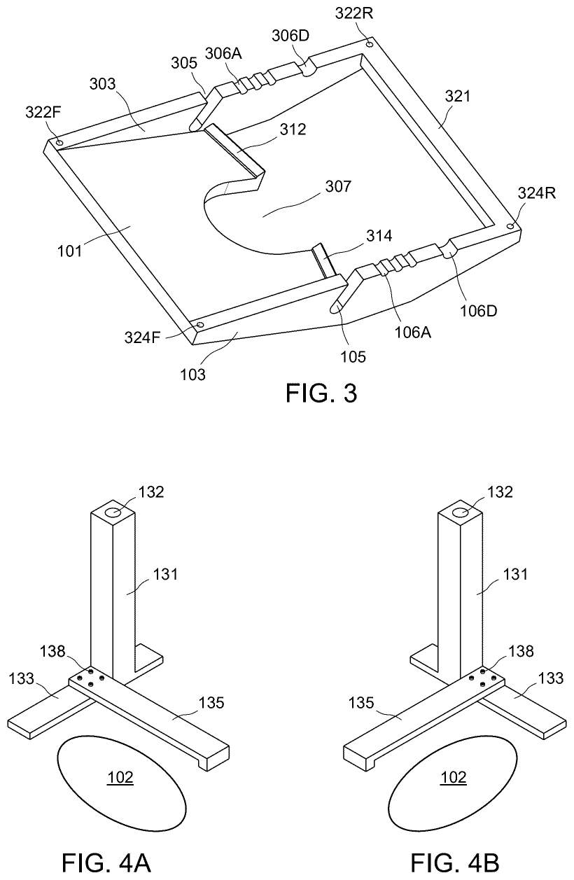

FIG. 3 is a perspective view of the bottom panel 101 and associated frame members according to embodiments of the present disclosure. The bottom panel 101, side frame members 103 and 303 and a rear frame member 321 are rigidly connected to form a frame of the basket 100 shown in FIG. 1. The side frame members 103 and 303 are symmetrical with symmetrical notches 105 and 305, and symmetrical grooves 106A-106D and 306A-306D.

Referring again to FIG. 3, the bottom panel 101 has a half-circular cut-out 307 at a far end of the bottom panel 101 to form a part of the opening 107 shown in FIG. 1. In an embodiment, the far end of the bottom panel 101 is bordered by protruding strips 312 and 314 on each side of the cut-out 307 to funnel water to the cut-out 307. In an embodiment, the bottom panel 101 is slanted downward toward the far end so that water can flow to the cut-out 307.

As shown in FIG. 3, there is a through-hole 324F at a near end of the side frame member 103, and a through-hole 324R at a far end of the side frame member 103. Symmetrically, there is a through-hole 322F at a near end of the side frame member 303, and a through-hole 322R at a far end of the side frame member 303. The ropes 162F, 162R, 164F and 164R go through the through-holes 322F, 322R, 324F and 324R, respectively, to hang the frame of the basket 100 to the crane 130 as shown in FIG. 1. In an embodiment, the ropes 162F, 162R, 164F and 164R are sections of one piece of rope with ropes 162R and 164R connected beneath the rear frame member 321, and 162F and 164F joint by a knot beneath the bottom panel 101.

FIGS. 4A and 4B are perspective views of the stand of the crane 130 shown in FIG. 1. The stand includes the vertical column 131 perpendicularly attached to the x-axis base board 133, and the y-axis base board 135 perpendicularly mounted to the x-axis base board 133 by screws 138. In an embodiment, the screws 138 includes 4 symmetrically located screws, so that the y-axis base board 135 can be mounted either extending to the left-hand side (when facing the screws 138 from the vertical column 131) of the x-axis base board 133 as shown in FIG. 4A, or extending to the right-hand side (when facing the screws 138 from the vertical column 131) of the x-axis base board 133 as shown in FIG. 4B. As shown in FIG. 4A, the bidet 102 is located on the left-hand side (when facing the vertical column 131 from the y-axis base board 135) of the y-axis base board 135. As shown in FIG. 4B, the bidet 102 is located on the right-hand side (when facing the vertical column 131 from the y-axis base board 135) of the y-axis base board 135. Such design of the symmetrical mounting screws 138 allows the stand with the same parts to be placed on either side of the bidet 102. The bidet 102 that provides the water stream for washing a baby according to embodiments of the present disclosure is mounted on the toilet (not shown).

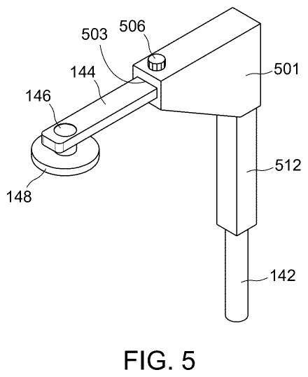

FIG. 5 is a perspective view of a part of the crane 130 according to embodiments of the present disclosure. The part of the crane 130 includes a bracket 501 with a triangular structure connecting the vertical pole 142 to the jib 144. In an embodiment, the vertical pole 142 has a square-cross-sectional section 512 at an upper section of the vertical pole 142 while the lower section of the vertical pole 142 has a round cross-section. In an embodiment, the bracket 501 forms a channel 503 to slidably engage the jib 144, so that a length of the jib 144 can be adjusted by sliding the jib 144 in or out of the channel 503. As shown in FIG. 5, a knob 506 drives a screw pin (not shown) to engage holes (not shown) in both the bracket 501 and the jib 144 so that the jib 144 can be secured to the bracket 501 with a desired length. In an embodiment, the jib 144 has multiple holes located along a length thereof, so that the jib 144 can be secured at various lengths.

Although the disclosure is illustrated and described herein as embodied in one or more specific examples, it is nevertheless not intended to be limited to the details shown, since various modifications and structural changes may be made therein without departing from the spirit of the disclosure and within the scope and range of equivalents of the claims. Accordingly, it is appropriate that the appended claims be construed broadly and, in a manner, consistent with the scope of the disclosure, as set forth in the following claims.

What is claimed is:

1. An apparatus for washing a baby, comprising:
a basket for carrying the baby, the basket having a bottom opening for exposing a bottom area of the baby; and
a crane suspending the basket for placing the bottom opening over a water stream.

2. The apparatus of claim 1, wherein the basket comprises a back panel pivotable around an axle situated in a notch formed in a frame of the basket, the axle protruding from a lower edge of the back panel and being at a same plane of the back panel, the back panel pivotable between a first and second angle of inclination in reference to the frame of the basket with the first angle larger than the second angle.

3. The apparatus of claim 2, wherein the back panel comprises a first cut-out at a lower edge of the back panel, the first cut-out forming a part of the bottom opening.

4. The apparatus of claim 2, wherein the back panel comprises a soft pad on a front surface of the back panel for receiving an upper body of the baby.

5. The apparatus of claim 2, wherein the back panel comprises a lower rigid section and an upper soft section.

6. The apparatus of claim 5, wherein the upper soft section is made of a fabric material removably stretched between a first and second pole member extending upward from a left and right side edge, respectively, of the lower rigid section.

7. The apparatus of claim 2, wherein the back panel comprises a first and second guide protruding from a front surface at a left and right side edge, respectively, of the back panel.

8. The apparatus of claim 7, further comprising a safety belt having a first end attached to the first guide and a second end attached to the second guide, the safety belt having a buckle situated between the first and second end of the safety belt.

9. The apparatus of claim 2, wherein the back panel comprises a first and second elongated block protruding from a back surface of the back panel, each of the first and second elongated block having a slot expanding along an elongated direction thereof for slidably containing a rod.

10. The apparatus of claim 9, wherein the frame of the basket comprises a groove for accommodating the rod to keep the back panel at the first angle.

11. The apparatus of claim 2, wherein the basket comprises a bottom panel fixedly attached to the frame of the basket, the bottom panel having a far area overlapping the lower edge of back panel, the far area being away from an edge of the basket.

12. The apparatus of claim 11, wherein the bottom panel has a second cut-out near the far area to form a part of the bottom opening.

13. The apparatus of claim 12, wherein the bottom panel is slanted downward toward the far area.

14. The apparatus of claim 13, wherein the bottom panel comprises a strip protruding above the far area to funnel water toward the second cut-out.

15. The apparatus of claim 1, wherein the crane comprises a stand, a vertical column mounted on the stand, and a jib rotatably engaging the vertical column for suspending the basket.

16. The apparatus of claim 15, wherein the stand comprises an x-axis base board with the vertical column mounted thereon, and a y-axis base board perpendicularly fastened to the x-axis base board by a plurality of symmetrically located fasteners to allow the y-axis base board to be fastened either to the left or to the right of the x-axis base board.

17. The apparatus of claim 15, wherein the jib comprises a first and second section, the first section rotatably engaging the vertical column, the second section slidably secured to the first section for adjusting a length of the jib.

18. The apparatus of claim 17, wherein the first section of the jib comprises a cylindrical member snuggly inserted in a vertical hole formed in the vertical column to allow the jib to rotate around the vertical column.

19. The apparatus of claim 17, wherein the second section of the jib comprises a shaft and an elongated board, the shaft being vertically attached to an end of the second section away from the first section and inserted in a hole in the elongated board, the elongated board being rotatable around the shaft and secured to the shaft by an endcap plate mounted to a bottom of the shaft.

20. The apparatus of claim 19, further comprising a first and second rope, the first rope connecting a first side of the basket to a first end of elongated board, the second rope connecting a second side of the basket to a second end of the elongated board.
